(19) United States
(12) Patent Application Publication
(10) Pub. No.: US 2018/0089997 A1
(43) Pub. Date: Mar. 29, 2018

(54) ROADSIDE DISPLAY SYSTEM, ROADSIDE UNIT AND ROADSIDE DISPLAY METHOD THEREOF

(71) Applicant: Industrial Technology Research Institute, Hsinchu (TW)

(72) Inventors: Kai-Yun HO, Hsinchu (TW); An-Kai JENG, Hsinchu (TW); Tzu-Hsiang SU, Hsinchu (TW); Pei-Chuan TSAI, Hsinchu (TW)

(21) Appl. No.: 15/716,087

(22) Filed: Sep. 26, 2017

Related U.S. Application Data
(60) Provisional application No. 62/399,708, filed on Sep. 26, 2016.

(30) Foreign Application Priority Data
May 10, 2017 (TW) 106115447

(51) Int. Cl. G08G 1/07; G08G 1/052

(52) U.S. Cl. CPC G08G 1/07; G08G 1/052

(57) ABSTRACT

A roadside display system, a roadside unit and a roadside display method thereof are provided. The roadside display system includes a sensor, a roadside unit and a display panel. The roadside unit receives object information of an object from the sensor. According to a notifying application and the object information of the object, the roadside unit determines based on an algorithm whether event information is generated, wherein the object information includes coordinate and speed information of the object. The display panel receives the event information from the roadside unit and displays the event information.

### BACKGROUND

### 1. Technical Field

The disclosure relates to a roadside display system, a roadside unit and a roadside display method thereof

### 2. Description of Related Art

Current road signs generally include: 1. Static electronic sign, which is static and may display fixed road information; 2. Changeable Message Sign (CMS), which is also static and displays information that can be updated by an onsite operation or a remote control center; and 3. Portable CMS, which is portable for use in solving a temporary traffic problem, and displays information that can be updated by an onsite operation. All these road signs are set to display information after an event has happened, but cannot update the displayed information in real time according to multi-party vehicle dynamics.

Conventional Advanced Driver Assistance Systems (ADAS) assist drivers in driving. However, as vehicle sensors (such as camera or radar) are limited to Line-of-Sight (LOS) detection, the systems may not work for Non-Line-of-Sight (NLOS) accidents caused by, for example, intersection collision or front vehicle emergency brake, etc. Therefore, the systems should be integrated with a roadside device and communication technology to provide better assistance for the drivers.

### SUMMARY

In view of the aforementioned shortcomings of the prior art, the present disclosure provides a roadside display system. The roadside display system comprises at least one sensor, a roadside unit and a display panel. The sensor is used to detect at least one object. The roadside unit receives object information of the object detected by the sensor. According to at least one notifying application and the object information of the object, the roadside unit determines based on an algorithm whether event informatation is generated, wherein the object information includes coordinate and speed information of the object. The display panel receives the event information from the roadside unit and displays the event information.

The disclosure provides a roadside unit. The roadside unit comprises a wireless communication circuit, an event determining module and a processor circuit. The processor circuit is coupled to the wireless communication circuit and the event determining module. When the roadside unit receives object information of at least one object from at least one sensor, wherein the object information includes coordinate and speed information of the object, the event determining module of the processor circuit determines based on an algorithm whether event information is generated, according to at least one notifying application and the object information of the object.

The disclosure provides a roadside display method. The roadside display method comprises: receiving object information of at least one object from at least one sensor; according to at least one notifying application and the object information of the object, determining based on an algorithm whether event information is generated by an event determining module, wherein the object information includes coordinate and speed information of the object; and transmitting the event information to a display panel, and displaying the event information by the display panel.

In order to facilitate understanding the present disclosure, embodiments thereof are described in conjunction with illustration of the appended drawings. In the following descriptions, additional features and advantages of the present disclosure are partially described, such features and advantages may become apparent from the descriptions or through implementations of the present disclosure. The features and advantages of the present disclosure can be appreciated and achieved with the help of the elements and various combinations thereof given by the appended claims. It should be understood that the aforementioned general descriptions and the following detailed descriptions are for illustrative and explanatory purposes only, and are by no means intended to limit the scope of the present disclosure set forth by the appended claims.

### BRIEF DESCRIPTION OF THE DRAWINGS

The present disclosure can be more fully understood by reading the following detailed description of the embodiments, with reference made to the accompanying drawings, wherein:

FIG. 1 is a schematic diagram showing operation of a roadside display system according to an embodiment of the disclosure;

FIG. 2 is a schematic block diagram showing a roadside unit according to an embodiment of the disclosure;

FIG. 3 is a flowchart of a roadside display method according to an embodiment of the disclosure;

FIG. 4 is a flowchart showing a roadside display method for a notifying application according to an embodiment of the disclosure; and

FIG. 5 is a schematic block diagram showing display panels displaying event info nation according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

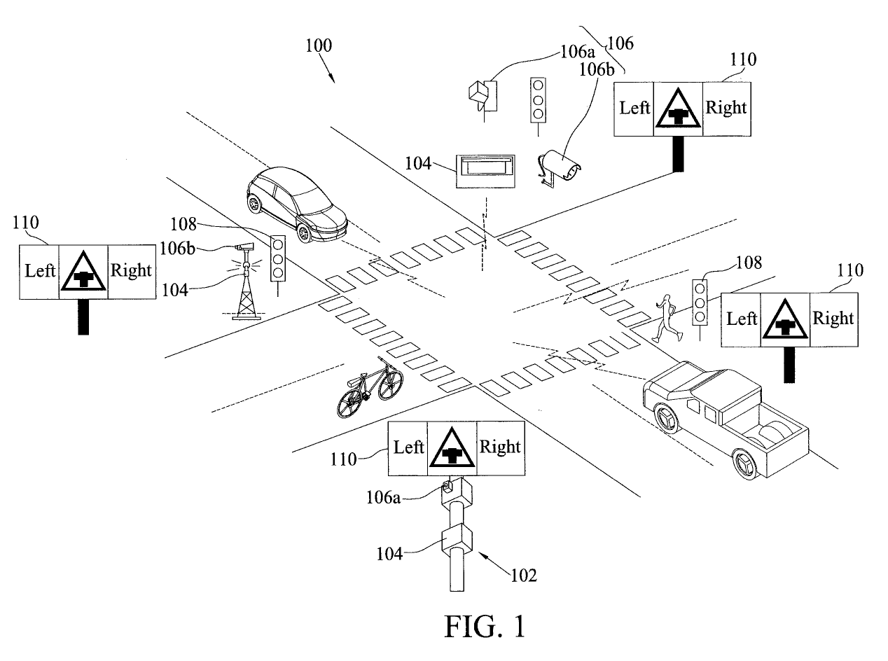

FIG. 1 is a schematic diagram showing operation of a roadside display system according to an embodiment of the disclosure.

As shown in FIG. 1, the roadside display system 100 comprises roadside infrastructure 102, a signal device 108 and a display panel 110. The roadside infrastructure 102 further comprises a roadside unit (RSU) 104 and at least one sensor 106. The sensor 106 can be a sensing unit such as a radar 106a, a camera 106b or a combination thereof, etc. The sensor 106 can be installed along a road or at an intersection, for detecting at least one object located within a detection range. The object to be detected by the sensor 106 within the detection range is for example, but not limited to, vehicle, motorcycle, bicycle or pedestrian.

The roadside unit 104 receives and collects object information of every object detected by the sensor 106, for example, vehicle dynamics in different directions at an intersection, which means the object information includes coordinates/positions and speeds of every object. The roadside unit 104 also may receive signal information transmitted from the signal device 108 and receive the object information of every object through wired/wireless communication from the sensor 106. According to different notifying applications and the object information of every object, the roadside unit 104 determines based on an algorithm whether event information is generated. And, the roadside unit 104 transmits the event information to the display panel 110. If the display panel 110 is a roadside sign or a road sign, it displays traffic condition information for passersby. In another embodiment, the roadside unit 104 determines whether event information is generated based on an algorithm according to different notifying applications and the signal information transmitted from the signal device 108, and transmits the event information to the display panel 110. This allows the display panel 110 to show vehicles or pedestrians in the vicinity the event information or a warning message in real time, so as to help prevent the occurrence of accidents. The notifying applications may include: Intersection Movement Assist (IMA), Emergency Electronic Brake Light (EEBL), Left Turn Assist (LTA), Forward Collision Warning (FCW), Blind Spot Warning/Lane Change Warning (BSW/LCW), Intersection Collision Risk Warning (ICRW), Longitudinal Collision Risk Warning (LCRW), Curved Road Speed Warning, or Road Hazard Signal (RHS).

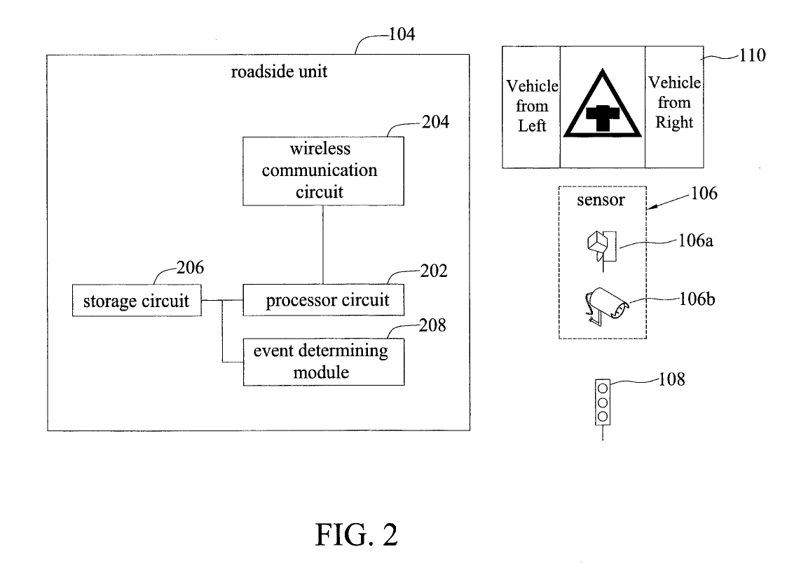

FIG. 2 is a schematic block diagram showing a roadside unit 104 according to an embodiment of the disclosure.

As shown in FIG. 2, the roadside unit 104 comprises a processor circuit 202, a wireless communication circuit 204, a storage circuit 206 and an event determining module 208.

In this embodiment, the processor circuit 202 is used to control overall operation of the roadside unit 104. The processor circuit 202 is for example, but not limited to, Central Processing Unit (CPU), Microprocessor, Digital Signal Processor (DSP), Programmable Controller, Application Specific Integrated Circuits (ASIC), Programmable Logic Device (PLD) or any other similar device. The wireless communication circuit 204 is coupled to the processor circuit 202. The wireless communication circuit 204 is for example, a communication chip that supports one or more of Global System for Mobile Communication (GSM) system, Personal Handy-phone System (PHS), Code Division Multiple Access (CDMA) system, Wireless Fidelity (WiFi) system, Worldwide Interoperability for Microwave Access (WiMAX) system, Third Generation Wireless Communication (3G), Long Term Evolution (LTE) and Wireless Access in Vehicular Environments/Dedicated Short Range Communication (WAVE/DSRC). The storage circuit 206 is used to store codes of the roadside unit 104, the event information being received, etc. The storage circuit 206 can be a storage unit such as disk, flash memory, and so on.

In this embodiment, as described above, the roadside unit 104 receives the object information of every object detected by the sensor 106 or the signal information transmitted from the signal device 108. The event determining module 208 of the roadside unit 104 includes a plurality of codes to determine based on an algorithm whether event information is generated, according to different notifying applications and the object information of every object and/or the signal information. In other words, for example, the event determining module 208 is embodied as software and stored in the storage circuit 206. When the roadside unit 104 is operating, the processor circuit 202 loads the codes of the event determining module 208 from the storage circuit 206 and performs the above function of determining based on an algorithm whether event information is generated according to different notifying applications and the object information of every object or the signal information. It should be noted that the disclosure is not limited to such arrangement. In another embodiment, the event determining module 208, which is able to determine based on an algorithm whether event information is generated according to different notifying applications and the object information of every object or the signal information, may be embodied as a hardware circuit in the processor circuit 202. Then, the roadside unit 104 sends the generated event information to the display panel 110 through wired or wireless transmission. In the case of wireless transmission, the roadside unit 104 may send the generated event information through the wireless communication circuit 204 to the display panel 110 where the event information is displayed. The roadside unit 104 further may send the generated event information through the wireless communication circuit 204 to a vehicle or object having an On-board Unit (OBU) in the vicinity, allowing the vehicle or object to receive the event information and display it on the OBU.

In an embodiment, the sensor 106 may be the radar 106a, the camera 106b, or a combination thereof. The object information detected by the sensor 106 includes, but not limited to, relative positions and relative speeds of the object with respect to the roadside unit, and a length of the object. In an embodiment, if the sensor 106 is the radar 106a, it uses radar detection technology to detect every object within a detection range to obtain object information of every object being scanned, wherein the object information may include relative positions (relative moving coordinates) and relative speeds of every object with respect to the roadside unit 104. Moreover, the roadside unit 104 receives information transmitted from the radar 106a to further obtain object positions and object speeds of every object. It should be noted that, the disclosure is not limited to using the radar detection technology for object detection, which is merely an example for illustration.

In an embodiment, if the sensor 106 is the camera 106b, it may use image recognition technology to recognize every object from images being taken and obtain object information of every object being captured, so as to accordingly calculate relative positions (relative moving coordinates) and relative speeds of every object with respect to the roadside unit 104, and transmit the object information of every object to the roadside unit 104. In another embodiment, the roadside unit 104 may in advance obtain GPS coordinates of the camera 106b and receive images from the camera 106b, such that the roadside unit 104 may recognize every object in the images according to the image recognition technology, so as to calculate object information such as relative positions (relative moving coordinates) and relative speeds of every object with respect to the roadside unit 104 and to further obtain object latitude and longitude coordinates and object speeds of every object. It should be noted that, the sensor 106 of the disclosure is not particularly limited as long as it can transmit object information being detected to the roadside unit 104 to have the roadside unit 104 obtain object information such as object latitude and longitude coordinates/positions and object speeds of every object.

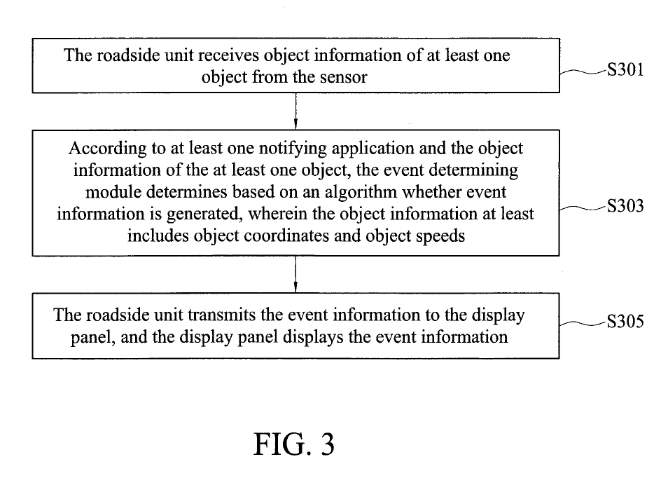

FIG. 3 is a flowchart of a roadside display method according to an embodiment of the disclosure.

Referring to FIG. 3 and the above FIG. 2, in step S301, the roadside unit 104 receives object information of at least one object from the sensor 106. The roadside unit 104 may also receive signal information from the signal device 108. In step S303, according to at least one notifying application and the object information of at least one object, the event determining module 208 determines based on an algorithm whether event information is generated, wherein the object information at least includes object coordinates and object speeds. In step S305, the roadside unit 104 transmits the event information to the display panel 110, and the display panel 110 displays the event information. In step S303, according to different notifying applications, the object information of at least one object and/or the signal information, the event determining module 208 further may determine based on an algorithm whether event information is generated; this is to be described later.

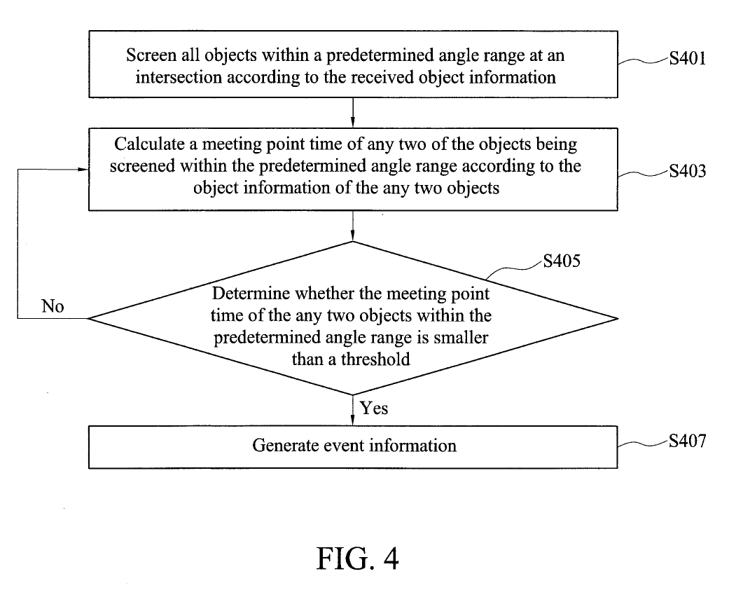

FIG. 4 is a flowchart showing a roadside display method for a notifying application according to an embodiment of the disclosure, for depicting further details of steps S303 to S305 of FIG. 3.

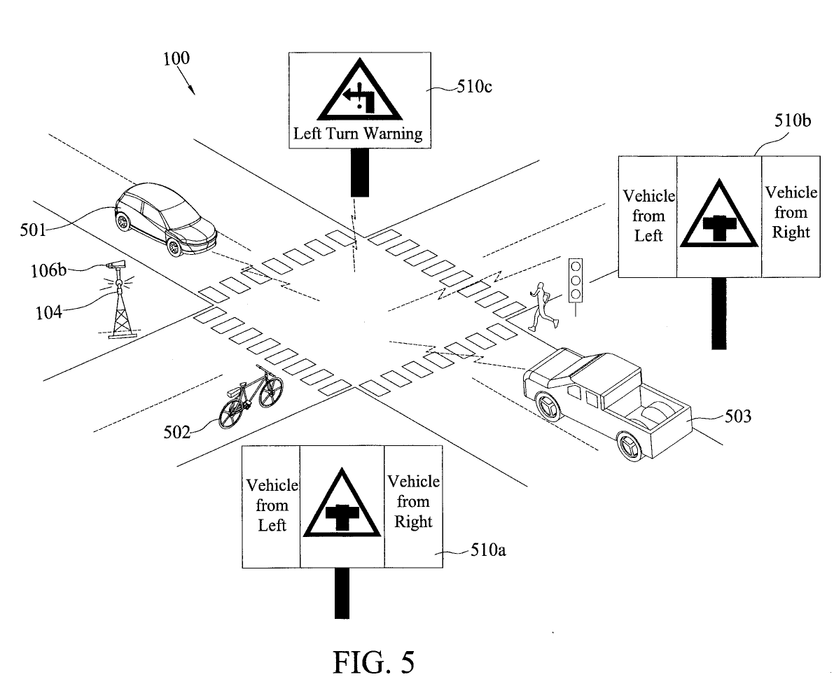

FIG. 5 is a schematic block diagram showing display panels displaying event information according to an embodiment of the disclosure.

Referring to FIGS. 4 and 5 and the above FIG. 2, in this embodiment, for example of Intersection Movement Assist (IMA) notifying application, in step 5401, the event determining module 208 of the roadside unit 104 screens all objects within a predetermined angle range (e.g. 70°˜110°) at an intersection according to the received object information. In step S403, the event determining module 208 calculates a meeting point time of any two of the objects being screened within the predetermined angle range according to the object information of the any two objects, wherein the meeting point time means a time after which the any two objects are going to meet. In step S405, the event determining module 208 determines whether the meeting point time of the any two objects within the predetermined angle range is smaller than a threshold (such as three seconds). If the meeting point time of the any two objects is not smaller than the threshold, it returns to step S403. If the meeting point time of the any two objects is smaller than the threshold, step S407 proceeds in which the event determining module 208 generates event information and transmits the event information to the display panel 510 where the event information is displayed.

Referring to FIG. 5 and the above FIG. 2, for example, at an intersection, the roadside unit 104 receives object information including a vehicle 501 on a longitudinal road and a bicycle 502 on a transverse road detected by the sensor 106. The event determining module 208 calculates a meeting point time of driving paths of the vehicle 501 and the bicycle 502 according to the IMA notifying application and the object information (such as positions and speeds) of the vehicle 501 and the bicycle 502, and determines whether the meeting point time of the vehicle 501 and the bicycle 502 is smaller than three seconds. If the meeting point time of the vehicle 501 and the bicycle 502 is determined to be smaller than three seconds, a collision between the vehicle 501 and the bicycle 502 may occur and thus the event determining module 208 generates event information. The roadside unit 104 transmits event information “Vehicle from Right” to a display panel 510a on the longitudinal road to show the vehicle 501 “Vehicle from Right” on the display panel 510a, making a driver of the vehicle 501 be aware of the bicycle 502 coming from a right direction. Simultaneously, the roadside unit 104 transmits event information “Vehicle from Left” to a display panel 510b on the transverse road to show the bicycle 502 “Vehicle from Left” on the display panel 510b, making a rider of the bicycle 502 be aware of the vehicle 501 coming from a left direction. This is thereby to prevent the collision. It should be noted that, if the vehicle 501 is equipped with an OBU, the roadside unit 104 may also transmit the event information “Vehicle from Right” to the OBU of the vehicle 501 such that the OBU can display “Vehicle from Right” to warn the driver of a vehicle coming from a right direction.

In another embodiment, if the vehicle 501 is equipped with an OBU (not shown) and the OBU includes an event determining module that is functionally same as that of the roadside unit 104, the roadside unit 104 may transmit object information of all objects within a predetermined angle range (e.g. 70°˜110°) to the OBU of the vehicle 501, wherein the object information includes object information of both the vehicle 501 and the bicycle 502. Then, the event determining module of the OBU calculates a meeting point time of driving paths of the vehicle 501 and the bicycle 502 according to the IMA notifying application and the object information (such as positions and speeds) of the vehicle 501 and the bicycle 502, and determines whether the meeting point time of the vehicle 501 and the bicycle 502 is smaller than three seconds. If the meeting point time of the vehicle 501 and the bicycle 502 is determined to be smaller than three seconds, a collision between the vehicle 501 and the bicycle 502 may occur, such that the event determining module generates event information “Vehicle from Right” and displays it on the OBU.

In another embodiment, for example of Left Turn Assist (LTA) notifying application, also referring to FIG. 5, the roadside unit 104 receives object information including a vehicle 503 on a longitudinal road and a bicycle 502 on a transverse road detected by the sensor 106. The event determining module 208 calculates a meeting point time of driving paths of the vehicle 503 and the bicycle 502 according to the LTA notifying application and the object information (such as positions and speeds) of the vehicle 503 and the bicycle 502, and determines whether the meeting point time of the vehicle 503 and the bicycle 502 is smaller than two seconds. If the meeting point time of the vehicle 503 and the bicycle 502 is determined to be smaller than two seconds, a collision between the vehicle 503 and the bicycle 502 may occur, and thus the event determining module 208 generates event information “Left Turn Warning”. The roadside unit 104 transmits event information “Left Turn Warning” to a display panel 510c on the longitudinal road to show the vehicle 503 “Left Turn Warning” on the display panel 510c, so as to warn a driver of the vehicle 503 of a danger if turning left to have a collision with the bicycle 502 coming from a left direction. Simultaneously, the roadside unit 104 transmits event information “Vehicle from Right” to a display panel 510b on the transverse road to show the bicycle 502 “Vehicle from Right” on the display panel 510b, making a rider of the bicycle 502 be aware of the vehicle 503 coming from a right direction so as to prevent the collision.

In another embodiment, for example of Emergency Electronic Brake Light (EEBL) notifying application, the roadside unit 104 receives object information including positions and speeds of two vehicles detected by the sensor 106. The event determining module 208 determines whether the two vehicles are too close to each other according to the EEBL notifying application and the positions and speeds of the two vehicles. If they are too close, the event determining module 208 generates event information “Vehicle too Close”, and the roadside unit 104 transmits the event information “Vehicle too Close” to a display panel.

In another embodiment, the event determining module 208 of the roadside unit 104 determines whether event information is generated for at least one object according to received object information of the at least one object and signal information. For example, if a vehicle runs a red light, the roadside unit 104 receives object information of at least one object and signal information, and the event determining module 208 further obtains acceleration of the object according to the object information and correspondingly in combination with the signal information determines whether to generate “Vehicle from Left” or “Vehicle from Right” event information. The generated event information is transmitted and displayed on a display panel to warn any vehicle running in an opposite direction. In another embodiment, the event determining module 208 further may directly determine whether a vehicle does not follow traffic signals according to object information (position information) and signal information, so as to generate event information and transmit it to and display it on a display panel.

In another embodiment, on a curved road, the roadside unit 104 may receive object information of a speed of a vehicle running on the road, and the event determining module 208 determines whether it is dangerous for the vehicle to run at the speed on the curved road according to the vehicle's speed and a notifying application (such as Curved Road Speed Warning) and further transmits event information “Danger” to a display panel to warn a driver of the vehicle.

In another embodiment, for a vehicle or object having an OBU that includes an event determining module functionally same as that of the roadside unit 104, the OBU may receive object information of every object and/or signal information transmitted from the roadside unit 104, and according to different notifying applications and object information of at least one object and/or the signal information, the event determining module of the OBU determines based on an algorithm whether event information is generated. The OBU displays the event information, and may further issue a warning message.

Accordingly, the roadside unit 104 transmits a packet through the wireless communication circuit 204 to a vehicle equipped with an OBU. In an embodiment, the roadside unit 104 may broadcast the packet through WAVE/DSRC standard specification, for example, Basic Safety Message (BSM) packet, wherein this packet may include basic safety message format. WAVE/DSRC can be Vehicle-to-Vehicle (V2V) communication, Vehicle-to-Roadside (V2R) communication and Vehicle-to-Infrastructure (V2I) communication, or generally named V2X communication technology. The disclosure is not limited to such disclosures. Thus, the vehicle having the OBU may receive V2X basic safety messages and be aware of any object in the vicinity (e.g. vehicle, motorcycle, bicycle or pedestrian), and an event determining module of the OBU may issue a warning message if there is an object too close to the vehicle so as to prevent a collision.

It should be noted that, in an embodiment, the sensor 106 and the roadside unit 104 are provided at the same location. In another embodiment, the roadside unit 104 may have a built-in sensor 106. This allows the sensor 106 and the roadside unit 104 to have the same GPS coordinates, and the sensor 106 detects object information including relative positions and relative speeds of an object with respect to the roadside unit 104 and transmits the object information to the roadside unit 104, such that the roadside unit 104 may according to the above disclosure obtain object latitude and longitude coordinates and object speeds of all objects being detected. In another embodiment, the sensor 106 and the roadside unit 104 may be provided at different locations. The roadside unit 104 can in advance obtain GPS coordinates of the sensor 106, or receive the GPS coordinates and object information from the sensor 106, such that the roadside unit 104 may obtain object latitude and longitude coordinates and object speeds of all objects being detected according to the GPS coordinates of the sensor 106 and object information received from the sensor 106.

Therefore, according to the roadside display system, the roadside unit and the roadside display method thereof disclosed in the above embodiments, the roadside unit may transmit event information of traffic conditions to a display panel, making a vehicle or object in the vicinity be aware of the event information from the display panel, so as to reduce the occurrence of accidents and solve the problem of low OBU penetration.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A roadside display system, comprising:
at least one sensor configured for detecting at least one object;
a roadside unit configured for receiving object information of the object from the sensor, and according to at least one notifying application and the object information of the object, determining based on an algorithm whether event information is generated, wherein the object information includes coordinate and speed information of the object; and
a display panel configured for receiving the event information from the roadside unit and displaying the event information.

2. The roadside display system as claimed in claim 1, further comprising at least one signal device, wherein the roadside unit is configured for receiving signal information from the signal device, and according to the at least one notifying application and the signal information, determining based on the algorithm whether the event information is generated.

3. The roadside display system as claimed in claim 2, wherein the roadside unit comprises a processor circuit, a wireless communication circuit and a first event determining module, wherein according to the at least one notifying application, the object information of the object and/or the signal information, the first event determining module of the processor circuit determines based on the algorithm whether the event information is generated.

4. The roadside display system as claimed in claim 3, wherein the wireless communication circuit of the roadside unit is configured for transmitting the object information of the object and/or the signal information to an object having an on-board unit, and the on-board unit comprises a second event determining module, wherein according to the at least one notifying application, the object information of the object and/or the signal information, the second event determining module is configured for determining based on the algorithm whether the event information is generated.

5. The roadside display system as claimed in claim 1, wherein the roadside unit is configured for calculating a meeting point time of any two of all objects within a predetermined angle range according to the at least one notifying application and object information of the any two objects, and determining whether the meeting point time is smaller than a threshold, wherein if the meeting point time is smaller than the threshold, the roadside unit is configured for generating the event information.

6. The roadside display system as claimed in claim 1, wherein the at least one notifying application comprises Intersection Movement Assist, Emergency Electronic Brake Light, Left Turn Assist, Forward Collision Warning, Blind Spot Warning/Lane Change Warning, Intersection Collision Risk Warning, Longitudinal Collision Risk Warning, Curved Road Speed Warning or Road Hazard Signal.

7. The roadside display system as claimed in claim 1, wherein the sensor comprises at least one radar or at least one camera, and is configured for using radar detection technology or image recognition technology to detect the object within a detection range to obtain the object infot illation.

8. A roadside unit, comprising:
a wireless communication circuit;
a first event determining module; and
a processor circuit coupled to the wireless communication circuit and the first event determining module,
wherein the roadside unit is configured for receiving object information of at least one object from at least one sensor, and the object information includes coordinate and speed information of the object, and
wherein according to at least one notifying application and the object information of the object, the first event determining module of the processor circuit determines based on an algorithm whether event information is generated.

9. The roadside unit as claimed in claim 8, wherein the roadside unit is configured for receiving signal information from a signal device, and according to the at least one notifying application and the signal information, determining based on the algorithm whether the event information is generated.

10. The roadside unit as claimed in claim 9, wherein the wireless communication circuit of the roadside unit is configured for transmitting the object information of the object and/or the signal information to an object having an on-board unit, wherein the on-board unit comprises a second event determining module, and wherein according to the at least one notifying application, the object information of the object and/or the signal information, the second event determining module is configured for determining based on the algorithm whether the event information is generated.

11. The roadside unit as claimed in claim 8, wherein the first event determining module of the processor circuit calculates a meeting point time of any two of all objects within a predetermined angle range according to the at least one notifying application and object information of the any two objects and determine whether the meeting point time is smaller than a threshold, wherein if the meeting point time is smaller than the threshold, the roadside unit is configured to generate the event information.

12. The roadside unit as claimed in claim 8, wherein the at least one notifying application comprises Intersection Movement Assist, Emergency Electronic Brake Light, Left Turn Assist, Forward Collision Warning, Blind Spot Warning/Lane Change Warning, Intersection Collision Risk Warning, Longitudinal Collision Risk Warning, Curved Road Speed Warning or Road Hazard Signal.

13. The roadside unit as claimed in claim 8, further comprising at least one sensor, wherein the sensor comprises at least one radar or at least one camera, and is configured for using radar detection technology or image recognition technology to detect the object within a detection range to obtain the object information.

14. A roadside display method, comprising:
receiving object information of at least one object from at least one sensor;
according to at least one notifying application and the object information of the object, determining based on an algorithm whether event information is generated by a first event determining module, wherein the object information includes coordinate and speed information of the object; and
transmitting the event information to a display panel, and displaying the event information by the display panel.

15. The roadside display method as claimed in claim 14, further comprising:
receiving signal information from a signal device, and according to the at least one notifying application and the signal information, determining based on the algorithm whether the event information is generated.

16. The roadside display method as claimed in claim 15, further comprising:
transmitting the object information of the object and/or the signal information to an object having an on-board unit, and according to the at least one notifying application, the object information of the object and/or the signal information, determining based on the algorithm whether the event information is generated by a second event determining module of the on-board unit.

17. The roadside display method as claimed in claim 14, further comprising:
calculating a meeting point time of any two of all objects within a predetermined angle range according to the at least one notifying application and object information of the any two objects by the first event determining module, and determining whether the meeting point time is smaller than a threshold, wherein if the meeting point time is smaller than the threshold, the event information is generated.

18. The roadside display method as claimed in claim 14, wherein the at least one notifying application comprises Intersection Movement Assist, Emergency Electronic Brake Light, Left Turn Assist, Forward Collision Warning, Blind Spot Warning/Lane Change Warning, Intersection Collision Risk Warning, Longitudinal Collision Risk Warning, Curved Road Speed Warning or Road Hazard Signal.
